(19) United States
(12) Patent Application Publication
(10) Pub. No.: US 2016/0200520 A1
(43) Pub. Date: Jul. 14, 2016

(54) CONVEYOR MODULE, CONVEYOR MAT OR CHAIN, METHOD FOR MONITORING WEAR OF A CONVEYOR ELEMENT, AND CONVEYOR SYSTEM

(71) Applicant: REXNORD FLATTOP EUROPE B.V., 's-Gravenzande (NL)

(72) Inventors: Cornelis Hendrik Mijndert Menke, Den Haag (NL); Andrea Andreoli, Modena (IT)

(21) Appl. No.: 14/912,126

(22) PCT Filed: Aug. 27, 2014
(86) PCT No.: PCT/NL2014/050578

§ 371 Date: Feb. 15, 2016

(30) Foreign Application Priority Data
Aug. 27, 2013 (NL) 2011341
May 7, 2014 (NL) 2012774

(51) Int. Cl. B65G 43/02; B65G 17/08

(52) U.S. Cl. CPC B65G 43/02; B65G 17/08

(57) ABSTRACT

The invention relates to a conveyor module for a conveyor mat and/or conveyor chain for conveying articles. The module (1) comprises a conveying face (2) for supporting articles to be conveyed, a supporting face arranged to be supported by a support member of a conveyor system and connectors (6) arranged such that front and rear sides of successive conveyor modules (1) can be hingedly coupled to each other. Furthermore, the module (1) comprises at least one marking body (10) for marking the conveyor module (1), wherein the marking body (C1-C2) extends from an inside (100) of the module at least towards an outer face (11) of the module.

The invention relates to a conveyor module. The invention further relates to a conveyor mat or chain, a conveyor system, and a method for monitoring wear of a conveyor element.

Such modules, mats or chains, and systems are generally known and are used for conveying products. Usually, the modules are manufactured by means of mold formation. Often, the modules are manufactured from plastic material and/or a metal or metal alloy.

A customary conveyor module comprises a conveying face for supporting articles to be conveyed, the conveying face being located at a top side of the module. At a bottom side of the module, a supporting face is provided, which is arranged to be supported by a support member, such as a conveying track, of a conveyor system. Further, the module comprises connectors arranged such that front and rear sides of successive conveyor modules can be hingedly coupled to each other.

Conveyor modules successive in conveying direction can be coupled to form a modular conveyor mat or chain of a desired length.

Generally, a conveyor system comprises a conveyor mat or conveyor chain, usually of endless design so that it can be led over a conveying track, e.g. by means of return wheels. The mat or chain can for instance be a modular conveying mat.

Normally, a conveyor element, such as a conveyor mat, chain, and/or module, wears during use. At a certain moment, the conveyor element needs to be replaced in order to counteract underperforming of a conveyor system. However, it is difficult to predict when a conveyor element is worn to such extent that it should be replaced, for instance because the wear rate can depend on varying factors, such as for example environment temperature, air humidity, conveying speed, and mass and surface roughness of the articles to be conveyed. Further, interrupting a production process for checking or measuring wear of a conveyor element can be unwanted, especially when such interruptions are more frequent and/or take a relatively long time. Another disadvantage of known conveyor elements may include that it can be difficult to examine whether or not a conveyor element is worn to such extent that it should be replaced. For example, when a top side comprising the conveying face is worn lightly and a supporting face at the bottom side of the module is worn heavily, the module may need to be replaced, but the thickness of the whole module can—due to the relatively light wear at the top side—incorrectly suggest that the module is still in good enough shape. Alternatively, for instance when the conveying and supporting faces both wear substantially equally, it can incorrectly be concluded that one of these faces has worn too much and that the conveyor element needs to be replaced. As a consequence of misjudging the state of wear of conveyor elements, conveyor elements may thus be replaced too early, which can cause unnecessary costs, unnecessary waste, and/or unnecessary shut down of a conveyor system. On the other hand, misjudging can also lead to omission of timely replacement, which can cause underperforming or even break down of a conveyor system. This can have severe consequences. For instance, if no replacement elements are present, a break down can cause long stoppage of production. Alternatively or additionally, a break down may do damage to other parts of a conveyor system and/or to products being conveyed, or may even injure workmen.

Further, it is noted that a conveyor mat or a conveyor chain is usually assembled at least partly by coupling a multiple number of conveyor modules to each other in order to form an endless mat or chain. Thereto, a string comprising a plurality of conveyor modules can be pre-assembled, e.g. in a conveyor module factory, for instance in order to limit the assembly time at the location where the conveyor mat or chain is to be installed. In this context, it is noted that a coupling between two of the modules comprised in a single pre-assembled string may be relatively firm and/or relatively lasting with respect to a coupling between two end modules located at respective ends of two separate strings, e.g. by providing said end modules, or so-called couple modules, with different connectors than other modules of the mat or chain. Said connectors of the couple modules may for instance be relatively easily coupleable and/or decoupleable. However, a disadvantage of such modules, mats and/or chains may be that, for instance during pre-assembling said strings and/or during servicing or disassembling the mat or chain, it can be hard to discern the couple modules and the other modules. Hence, e.g. pre-assembling the strings and/or servicing or disassembling the mat or chain, can be relatively difficult, laborious and/or time consuming.

Another disadvantage associated with known conveyor modules is that it can be relatively hard to identify a correct replacement module for a worn and/or damaged module, and, e.g. due to the fact that there are numerous different types of modules on the market.

It can also be relatively hard to tell apart modules of different suppliers and/or manufacturers. This situation can be undesirable, for example, because it can be hard for a user of a conveyor system to assess the quality of conveyor modules currently in use with said system when the supplier and/or manufacturer of said modules are not known.

An object of the invention is to provide an alternative conveyor module, an alternative conveyor mat or chain, and/or an alternative conveyor system. It is an object of the present invention to alleviate or solve at least one of the disadvantages of the prior art, especially a disadvantage mentioned above. In particular, the invention aims at providing a conveyor module, a conveyor mat or chain, a conveyor system and/or method for monitoring wear of a conveyor element, wherein at least one of the disadvantages mentioned above is counteracted or advantages there above are obtained. In embodiments, the invention aims at providing a method for monitoring wear of a conveyor element which is relatively simple and/or relatively sure. In embodiments, the invention aims at providing a conveyor module, conveyor mat or chain, and/or a conveyor system, and/or a method, which can facilitate an relatively untrained workman to make a relatively good judgment whether or not a conveying element is worn to such extent that it should be replaced. In embodiments, the invention aims at providing a conveyor module, conveyor mat or chain, and/or a conveyor system, and/or a method, which can facilitate that a couple module can be discriminated relatively easily from another module for a same conveyor mat or module, which can facilitate that a conveyor element such as module, mat or conveyor can be set apart from a conveyor element from another supplier and/or manufacturer, and/or which can facilitate that a certain module, e.g. a certain replacement module, can be distinguished relatively easily and/or relatively well from a module of a different type.

In a first aspect of a conveyor module of the present invention, the module is suitable for a conveyor mat and/or conveyor chain for conveying articles, and comprises a conveying face for supporting articles to be conveyed, the conveying face being located at a top side of the module, a supporting face arranged to be supported by a support member of a conveyor system, the supporting face being located at a bottom side of the module, and connectors arranged such that front and rear sides of successive conveyor modules can be hingedly coupled to each other, wherein the module further comprises at least one marking body for marking of the conveyor module, the marking body extending substantially from inside the module at least in a direction towards an outer face of the module.

Preferably, the marking body may, from the inside of the module, extend at least towards a conveying face and/or a supporting face of the module, preferably it can extend up to the conveying face and/or supporting face such that an outer surface of the marking body then forms a smooth surface part of the conveying face and/or supporting face of the module. The marking body may substantially wear with the conveying face and/or supporting face.

By arranging the conveyor module such that a marking body extends substantially from inside the module at least in a direction towards, and preferably up to, an outer face of said module, a conveyor module can be provided which can be distinguishable relatively easily when, or even when, the module has worn to a certain extend. For instance, it can thus be facilitated that a mark—e.g. a trade mark, type mark or model mark—can be visible at a module outer surface which is subjected to substantial wear. This can be advantageous with respect to a marking at a surface which is less susceptible to wear, such as a side surface of the module, because such surface can often be hidden from view during use of the module. Furthermore, since the marking body can extend through at least substantial part of the module and may wear with the respective outer face of the module, the marking can be relatively lasting, e.g. with respect to a painted marking or a sticker on an outer surface of the module.

In embodiments, it is possible that the marking body can extend beyond the conveying face and/or the supporting face. For instance, a part of the marking body may then extending out of the conveying surface. This can increase the friction between the conveying products and the conveyor belt. The marking body may also end before it reaches the conveying face and/or supporting face. For example, an outer surface of the marking body can then remain inside an cavity provided in the module body, but it may still be visible, even when the module is not worn up to the level of the outer surface of the marking body.

The outer surface of the marking body can preferably be located substantially near the center of the conveying face or the supporting face. It is also possible that the outer surface of the marking body is located on the right and/or left side with respect to the center of the conveying face and/or supporting face. Furthermore, it is possible that the module comprises multiple marking bodies.

To have a reliable fixation between the marking body and the module body, the marking body can be an insert that may be pressed into a cavity provided by the module body such that the marking body can be fixedly held inside the cavity, e.g. by means of form closure and/or plastic deformation of the marking body and/or the module body. The marking body may for example remain visible to a person when the module is subjected to wear, even when the module has been worn to a certain extent.

Alternatively, the marking body can be an insert included in an insert-molded conveyor module. The conveyor module body can then be molded around the insert.

The module body may be manufactured from a different material than the marking body. For an user it may then be relatively easy to distinguish the marking body from the conveyor module body. Preferably, the marking body can be manufactured from plastic, whereas the module body can be manufactured from metal.

The marking body may be provided with a color or color scheme being different than a color or color scheme of local material of the conveyor module body adjacent to the marking body such that the marking body and the module body can be distinguished from each other by a person.

In embodiments, cross-sections of the marking body, which cross-sections may be located along at least a part of the path along which the marking body extends at least in the direction towards the outer face of the module, can have substantially the same visual appearance, cross-section contour, size and/or color or color scheme. However, it is also possible that the cross-sections of the marking body may have different visual appearance, cross-section contour, size and/or color or color scheme, e.g. depending on the marking purposes of the marking body.

For example, the marking body may indicate the origin of the module. Therefore, when a user has multiple conveyor mats or chains, he can relatively easily determine e.g. the manufacturer of the module. Besides the origin of the module, the marking body may also indicate the type or model of the conveyor mat or conveyor chain, and/or (technical) specifications of the conveyor mat or conveyor chain. Because the marking body may wear with the conveying face or supporting face of the module body, the information provided by the marking body can remain substantially visible to the user.

In embodiments, the marking body may allow the user to easily determine the top side or the bottom side of the module.

The marking body may be also be used to indicate a couple module of an endless conveyor mat or chain. Normally, a number of modules may be coupled to form a string of modules of about 1 to 5 meter, e.g. about 3 meter. This is conventionally done by passing a hinge pin axially through aligned hinge receiving spaces of cooperating hinge loops of consecutive modules. Each pre-assembled string comprising successive modules already hingedly coupled to each other, which may facilitate a user in assembling a conveyer mat or chain. The user can then couple the strings to each other to form an endless conveyor mat or chain, e.g. at the location of the conveyor track. The couple module of each string, normally the first module and/or the last module of the string, can be easily coupled to the next string. For example, connectors of the couple module can be coupled onto the hinge pin of other module of a string and therefore the user may not need many additional tools, such as a hammer, in order to couple the strings of modules to each other. By using the marking body as a couple module indicator, the user can easily detect which modules of the endless conveyor mat or chain are couple modules, and in particular the user can relatively quickly detect a couple module when servicing or dismounting the conveyor mat or chain. The user may then simply dismount the endless modular mat or chain by, for instance, uncoupling the couple module.

In another embodiment, the marking body may be a wear indicator for visual inspection of wear of the conveyor module. By providing the module with a wear indicator having different cross-sections with different visual appearances, it can be provided that there is a clear difference between an unworn state of a respective outer face, e.g. a conveying face or a supporting face, and a worn state of said outer face. When the module is unworn, the first cross-section, which can be located at the unworn outer face can namely be visible, whereas the second cross-section, which can be provided below the first cross-section, can be exposed when said outer face of the module is worn to a certain predetermined extent. As a result of the clear difference between the visual appearances of both cross-sections, misjudging the state of wear of conveyor elements can be counteracted. Hence, unnecessary costs, unnecessary waste, unnecessary delay, and/or underperforming or break down of a conveyor system can be counteracted. Besides, due to the different visual appearances, checking a state of wear of an conveyor element may be relatively simple, easy and/or fast, and/or may be even be done without interrupting conveyance of articles.

The invention further relates to a method for monitoring wear of a conveyor element, such as a modular conveyor mat and/or conveyor chain.

Advantageous embodiments according to the invention are described in the appended claims.

By way of non-limiting examples only, embodiments of the present invention will now be described with reference to the accompanying figures in which:

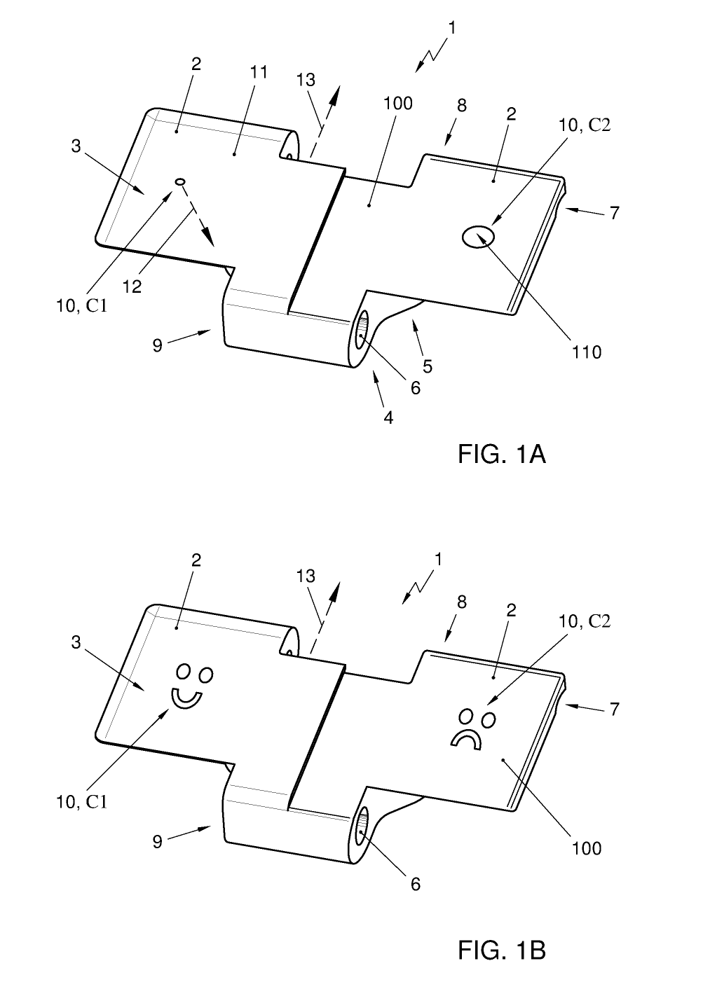

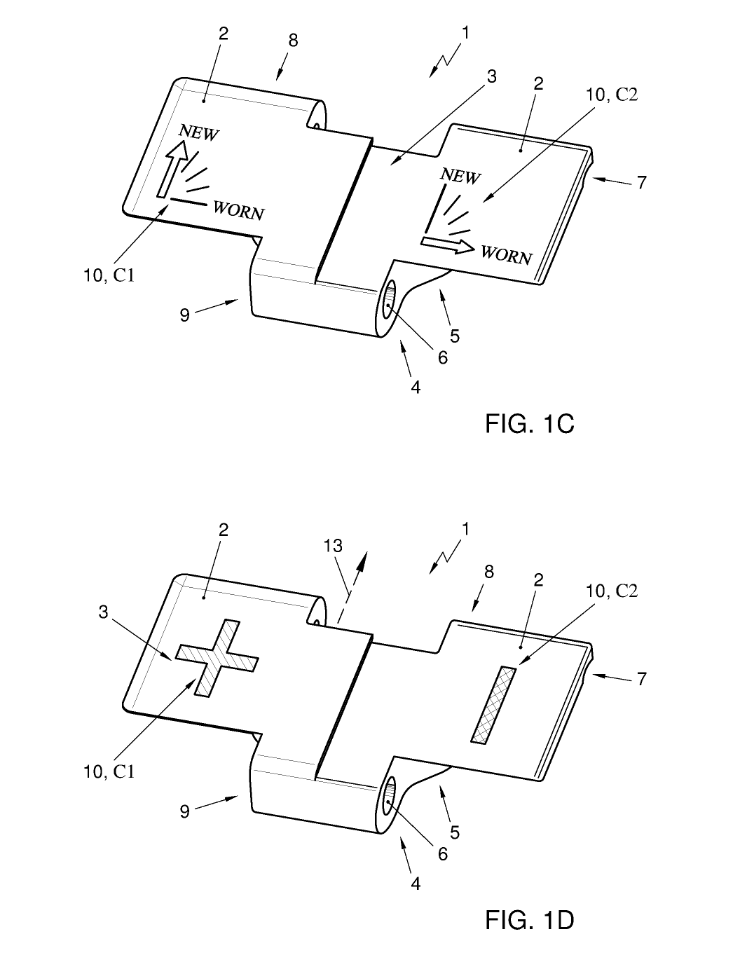

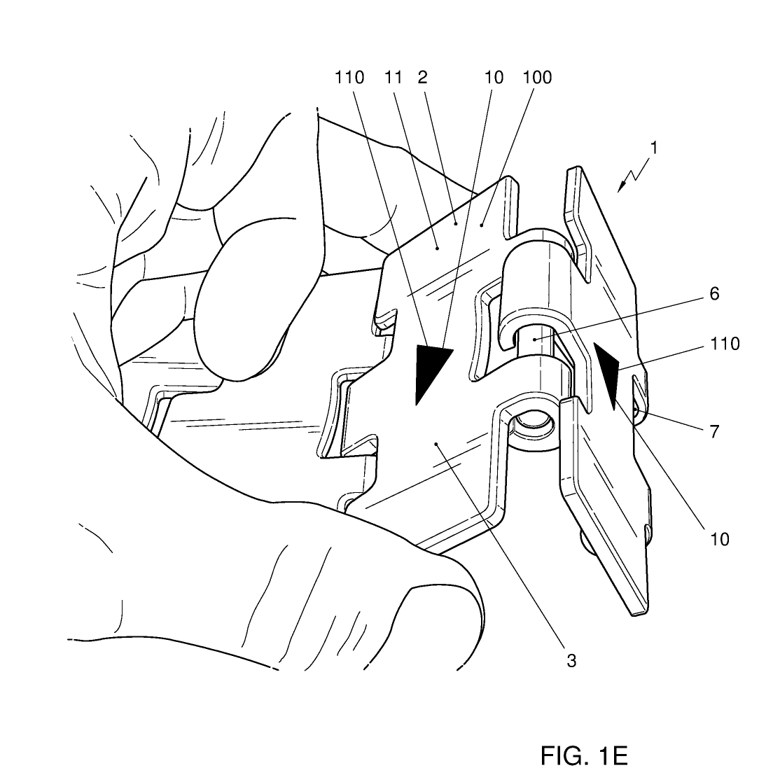

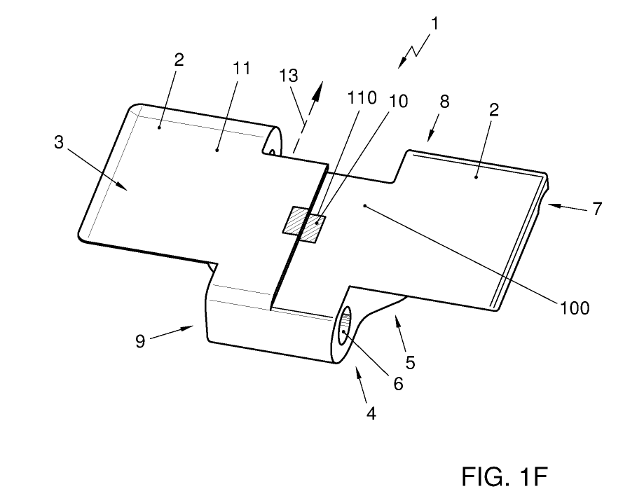

FIG. 1A shows a schematic perspective, partly cutaway view of a first embodiment of a conveyor module according to the invention;

FIG. 1B shows a schematic perspective, partly cutaway view of another embodiment of a conveyor module according to the invention;

FIG. 1C shows a schematic perspective, partly cutaway view of another embodiment of a conveyor module according to the invention;

FIG. 1D shows a schematic perspective, partly cutaway view of another embodiment of a conveyor module according to the invention;

FIG. 1E shows a schematic perspective view of another embodiment of a conveyor module according to the invention;

FIG. 1F shows a schematic perspective view of an another embodiment of a conveyor module according to the invention;

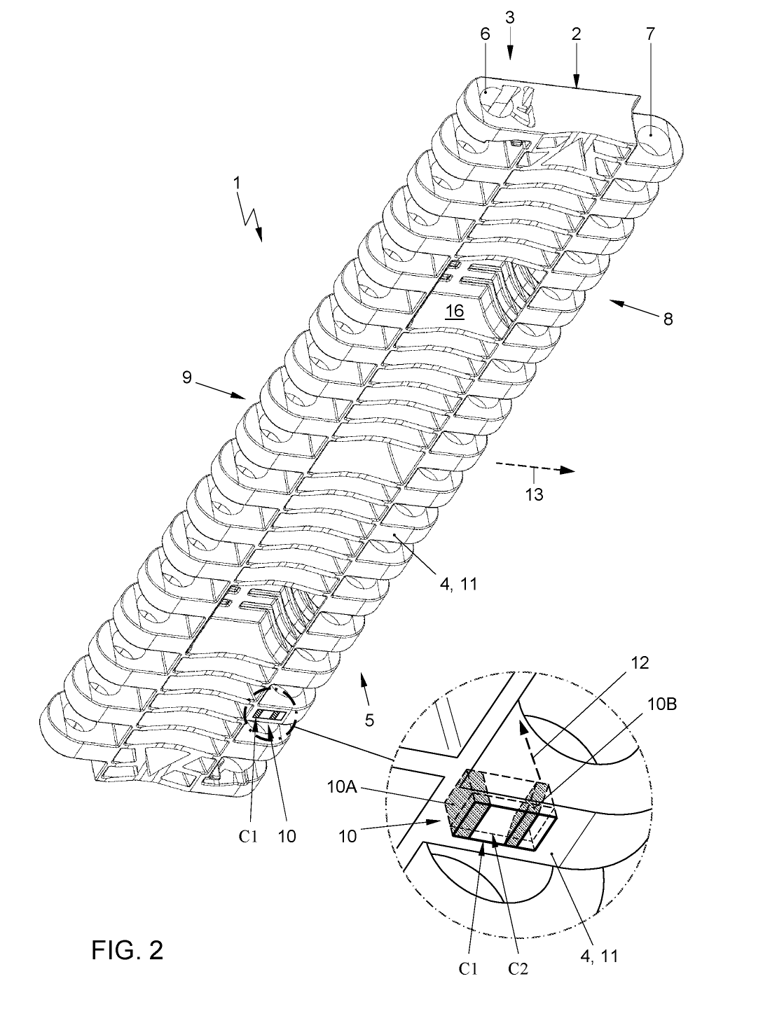

FIG. 2 shows a schematic perspective bottom view of another embodiment of a conveyor module according to the invention;

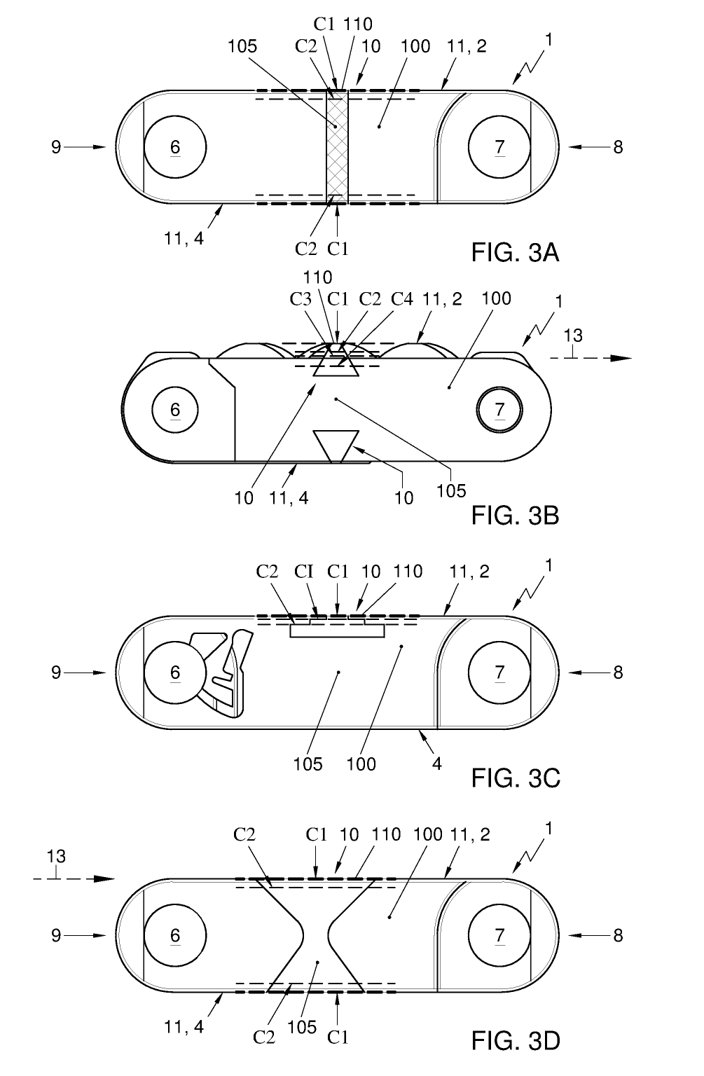

FIG. 3A shows a schematic side view of another embodiment of a conveyor module according to the invention;

FIG. 3B shows a schematic side view of another embodiment of a conveyor module according to the invention;

FIG. 3C shows a schematic side view of another embodiment of a conveyor module according to the invention; and

FIG. 3D shows a schematic side view of another embodiment of a conveyor module according to the invention.

The embodiments disclosed herein are shown as examples only and should by no means be understood as limiting the scope of the claimed invention in any way. In the description, the same or similar parts and elements have the same or similar reference signs.

In general terms, the present invention can be understood as directed to a conveyor element, such as a conveyor mat or chain, or a module thereof, comprising a marking body extending from inside the element, at least in a direction to a face subject for marking.

FIGS. 1A-1D show a schematic perspective, partly cutaway views of embodiments of conveyor modules 1 according to the invention, in which the modules are substantially seen from above. In each of these embodiments, the conveyor module 1 is suitable for a conveyor chain for conveying articles. Additionally or alternatively, such as in the embodiment of FIG. 2 showing an embodiment of a conveyor module 1 according to the invention, the modules 1 can be suitable for a conveyor mat.

The conveyor module 1 comprises a conveyor module body 100 having a conveying face 2 for supporting articles to be conveyed. The conveying face 2 is located at a top side 3 of the module 1. It is noted that in this description a top side 3 of a module 1, chain or mat has to be understood as at least including but not necessarily limited to a side which during use of said chain or mat or use of an endless chain or mat comprising said module body 100 is facing substantially upward during the conveying upper run and is facing substantially downward during the returning bottom run.

The module body 100 also comprises a supporting face 4 arranged to be supported by a support member of a conveyor system. Advantageously, the supporting face 4 is positioned substantially opposite the conveying face 2.

It is noted that a support member of a conveyor system can be or comprise a conveying track for supporting an upper run of an endless conveyor mat or chain at least partly. Further, a return guide and/or driving means for cooperating with a mat or chain and/or one or more modules thereof can form one or more support members of a conveyor system.

The supporting face 4 of the module body 100 is located at a bottom side 5 of said module 1. Preferably, the supporting face 4 can comprise a substantially flat contact area for slidingly contacting the support member, especially the conveying track and/or return guide.

As can be seen in FIGS. 1A-3A, 3C and 3D, the conveying face 2 can comprise a substantially flat contact area for contacting articles to be conveyed supported by the module 1. However, in alternative embodiments, the conveying face 2 may be provided with relief. For example, the conveying face 2 can be provided with recesses and/or protrusions, for instance ribs or tear drops, such as shown in the embodiment of FIG. 3B, to augment grip. It is noted that the conveying face 2 can extend in a plane substantially parallel with a conveying direction 13, especially substantially parallel with the supporting face 4. However, in embodiments, the conveying face 2 may extend in another direction. For example, when the conveying direction 13 slopes downward or upward, the conveying face 2 can be arranged to extend at an angle with the conveying direction 13 and/or the supporting face 4, such that said conveying face can extend substantially horizontally during the upper run of the mat or chain. Advantageously, the module 1 may be arranged such that during use the conveying face 2 extends substantially in the horizontal plane during the upper run.

The conveyor module body 100 also comprises connectors 6, 7 arranged such that front and rear sides 8, 9 of successive conveyor modules 1 can be hingedly coupled to each other. By connecting the modules 1, an endless conveyor mat or chain can be formed. Here, the connectors 6, 7 comprise hinge holes 6, 7 for cooperation with hinge pins for hingedly connecting successive modules 1. However, in alternative embodiments, the module may alternatively or additionally be provided with other connectors, preferably hinge parts, such as an integrated connector pin protruding from the body part. Here, the module body 100 comprises one first connector hole 6 extending through the module in a direction substantially transverse to a conveying direction 13, and substantially parallel with the conveying face 2 and/or supporting face 4.

In FIGS. 1A-1D, one first connector 6 is provided at the rear side 9 of the module body 100 and two connectors 7 (not shown) are provided at the front side 8 of the module body 100, which can be hingedly connected to the first connector 6 by means of a hinge pin. Alternatively, another number of connectors can be provided at the front or rear side. Preferably, the connectors 6, 7 or so-called coupling elements 6, 7 at both the front and the rear side 8, 9 comprise one or a series of successive hinge parts with one or more adjacent receiving spaces. For example, in case of a module 1 for a conveyor mat, such as for instance shown in FIG. 2, multiple coupling elements and adjacent receiving spaces are alternating transversely to the conveying direction 13 at both the front as the rear side, so that coupling elements and receiving spaces can interdigitate with receiving spaces and coupling element of similar modules 1 successive in the conveying direction 13. Successive modules 1 can be hingedly coupled by means of hinge pins reaching transversely to the conveying direction 13 through hinge holes 6, 7 provided by the hinge parts 6, 7.

Furthermore, the conveyor module 1 comprises at least one marking body 10 for marking the conveyor module 1. The marking body 10 extends from an inside 105 of the module at least in a direction towards an outer face 11 of the module 1.

Advantageously, said outer face 11 can be the conveying face 2 or the supporting face 4 of the module 1, for example, that one of these two surfaces which is expected to be worn firstly. Further, the outer face 11 may be a driving face, for instance a driving face for cooperation with driving means, such as teeth of a drive wheel.

In embodiments, such as for instance the embodiment shown in FIGS. 3A, 3B, and 3C, the conveyor module 1 can comprise one or more marking bodies 10 at the conveying face 2 and also one or more marking bodies 10 at the supporting face 4. These at least two marking bodies 10 can be two separate or individual marking bodies 10, see e.g. FIG. 3C. Alternatively, the at least two marking bodies 10 can be integrated into an integrated or double marking body 10 for marking two different faces 2, 4.

In FIGS. 3A-3D is shown that the marking body 10 is arranged such that it is extending substantially to the conveying face 2 and/or supporting face 4. An outer surface 110 of the marking body 10 may extend up to an opening forming an outer border of a cavity that is provided in the module body 100 such that the outer surface 110 of the marking body 10 substantially forms part of the conveying face 2 and/or supporting face 4 of the module 1. Hence, the marking body 10 may be clearly visible.

Alternatively, the outer surface 110 can be located inside 105 the module body, but may be still visible in the cavity provided in the module body 100. Hence, there may be small recesses on the conveying face 2 and/or supporting face 4. It is also possible that the marking body 10 may extend beyond the opening of the cavity provided in the module body 100. Hence, the outer surface 110 of the marking body 10 may form a small protrusion on the conveying and/or supporting face.

In embodiments, the marking body 10 can be an insert, preferably a pre-fab marking body 10. Advantageously, a conveyor module, mat or chain can be provided with a cavity, and the marking body 10 may be placed into the cavity provided by the module body 100. Preferably, the marking body 10 is fixed in said hole, e.g. by adhering, gluing, form closure or soldering or other suitable means. Additionally or alternatively, when the marking body 10 is pressed into the cavity, the marking body 10 and/or the module body may deform such that the marking body 10 can be clamped into the cavity.

Further, the insert may be included in an insert-molded conveyor module by firstly providing said insert in a mold and subsequently molding the conveyor module body 100 substantially around said insert. An advantage of an insert-molded conveyor module may be that the three-dimensional shape of the marking body can be chosen such that the marking body 10 can be locked-up in the conveyor module body 100, i.e. the marking body 10 can have a non-releasing shape, such as for instance a flattened cone-shape as shown in FIG. 3B or a diabolo-shape or hourglass-shape as shown in FIG. 3D.

Alternatively to inserting a prefab marking body, the marking body 10 can be formed inside a cavity or hole provided in the module, mat or chain, e.g. by pouring, casting, molding and/or sintering it in said hole. The hole may for instance be made by drilling or milling, and may have any suitable shape. For instance, the hole can be a blind hole or a through hole. It is noted that the marking body 10 can be formed in multiple steps, for instance, by pouring a material having a first color into the hole, and subsequently forming a further part of the marking body 10, e.g. by pouring a material having another color into said hole on top of the material having the first color.

The marking body 10 can be made of and/or comprise any suitable material or materials, such as a plastic, metal and/or metal alloy.

In embodiments, the marking body 10 can be made of and/or comprise a material being substantially as durable as the material of the conveyor element surrounding it. Preferably, the material or materials of the marking body may be or comprises a different material than the local material of the conveyor module body adjacent to the marking body. For example, the marking body 10 may be manufactured from plastic and the adjacent material of the module body may be manufactured from metal or metal alloy, or vice versa.

Alternatively, the material or materials of the marking body 10 may be or comprise the same material or materials as at least the surrounding parts of the conveyor element. For example, the marking body 10 and the conveyor module body 100 can both comprise the same or a similar plastic, or a same or similar metal or metal alloy.

The marking body 10 may have a hardness substantially equal to the hardness of the material of the conveyor element surrounding it. However, in alternative embodiments, the material of the marking body 10 and the surrounding material may have a different degrees of hardness, i.e. the material of the marking body 10 can have a lower or higher hardness than the surrounding material.

The marking body 10 may have a different color or color scheme than a color or color scheme of local material of the conveyor module body 100 adjacent to the marking body 10.

During use of the module 1, the marking body 10 may have a visual appearance of a symbol such as a dot “O”, or a triangle “▴” or a square “□”, which symbol may for example be filled with color, for instance, red. In embodiments, the marking body 10 may for example be located substantially near the center of the conveying face 2 and/or supporting face 4.

In embodiments, cross-sections of the elongated marking body 10, which cross-sections may be located along at least a part of the path along which the marking body 10 extends at least in the direction towards the outer face 11 of the module 1, can have substantially the same visual appearance, cross-section contour, size and/or color or color scheme.

It is, however, noted that the marking body 10 is not limited to the abovementioned shapes and the like and can have different visual appearances and/or shape and/or colors and/or location and/or changing cross-sections along the path the marking body 10 extends, e.g. depending on its marking purposes.

For instance, the marking body 10 may indicate the origin of the conveyor mat or conveyor chain. Text and/or logo representing a manufacturer can then be pressed into one or more cavities provided by the module body 100. The text can also contain (technical) specifications of the conveyor mat or conveyor chain.

Alternatively, the marking body 10 may be, for example, a couple module indicator for indicating which modules of the conveyor mat or conveyor chain are couple modules. As shown in FIG. 1E, the marking body 10 may for example have a visual appearance of a symbol such as a triangle, and preferably at least one triangle that is pointed to another adjacent module. Additionally or alternatively, the marking body 10 may also comprise a text, such as for example: “COUPLE MODULE”.

Advantageously, the marking body can be a wear indicator for visual inspection of wear of the conveyor module 1. The wear indicator can be arranged such that the conveyor module looks differently when it is substantially worn than when it is not worn or not worn that much.

The wear indicator 10 can be arranged such that a first cross-section C1 of the wear indicator 10 located at said outer face 11 of the conveyor module 1 has a different visual appearance than a second cross-section C2 of the wear indicator 1 offset from the first cross-section C1 in the direction 12 into the module 1.

FIGS. 1A-1D show schematic perspective, partly cutaway views of conveyor modules 1. At the right-hand side of these figures, a top layer of the module 1 is cutaway up to the level of the second cross-section C2, here corresponding with a worn state of the conveying face 2, whereas at the left-hand side of the same figures, no parts of the modules 1 are cutaway. At the left-hand sides of each of these modules 1, an unworn part of the conveying face 2 is visible, including the first cross-section C1 of the respective wear indicator 10.

For explanatory reasons, the conveying faces 2 of the modules 1 of FIGS. 1A-1D have been provided with the same wear indicator 10 twice, one at the left-hand side of which the first cross-section C1 is visible and one at the right-hand side of which the corresponding second cross-section C2 is visible. As can be seen, these two cross-sections C1, C2 of a same wear indicator 10 look different, i.e. have different visual appearance, such that an unworn state of the respective outer face 11, here the conveying face 2, can be distinguished visually from a worn state of said outer face 11. However, in other embodiments, a respective outer face 11 subject to wear may be provided with another number of wear indicators, for instance one, three or four wear indicators 10.

The two cross-section C1, C2 can have a different visual appearance, for example at least partly due to mutually different sizes of said wear indicator cross-sections C1, C2, such as is shown e.g. in FIG. 1A. Here in FIG. 1A, both cross-sections have substantially the same form or so-called shape, but in alternative embodiments, the cross-sections can alternatively or additionally to having a different size, have different forms or shapes, such as for instance shown in FIGS. 1B and 1D.

Advantageously, for instance in case of visual inspection of the state of wear of the outer surface 11 by a human observer, the visual appearance of the first cross-section C1 can be associative with an unworn conveyor module 1, and the visual appearance of the second cross-section C2 can associative with a worn conveyor module 1. For example, such as shown in FIG. 1D, the first cross-section C1 can be provided with a color associative with an unworn state, such as the color green, white, black or blue, whereas the second cross-section C2 can be provided with a color associative with a worn state, preferably a color substantially opposite to the color of the first cross-section, such as the color red, black, white or yellow. Such as shown in the embodiment of FIG. 1D, the first and/or second cross-section C1, C2 can be provided with a single color. However, in alternative embodiments, one or both cross-sections can be provided with multiple colors. Said multiplicity of colors may form a color scheme being different from the color or color scheme of other cross-section.

In the embodiments shown in FIGS. 1A-1D, each of the first and second cross-sections C1, C2 is provided with a color or color scheme being different than a color or color scheme of local material of the conveyor module 1 adjacent to the wear indicator 10. However, in embodiments, the color or color scheme of at least a part of one of said cross-sections C1, C2 can be substantially equal or similar to the color or color scheme of said local material of the module 1. When for instance only the second cross-section C2 is provided with a color contrasting with its surroundings, the wear indicator 10 can be not substantially visually noticeable until the respective outer surface 11 is worn to such extent that said second cross-section C2 will be exposed due to wear off of the part of the wear indicator 10 including the first cross-section C1 previously covering said second cross-section C2, which thereby can indicate that the module 1 or the mat or chain needs to be replaced.

Alternatively or additionally its colors, the form or shape of the cross-sections, especially a text and/or figure such as a symbol, may be associative with unworn and worn states, respectively. For example, the first cross-section C1 of the wear indicator 10 can be shaped such as to be associative with “fresh”, “continuing”, “good”, “positive” and/or “safe”, and may comprise a symbol, such as for instance a happy smiley “:)” or a plus sign “+” or a thumbs up symbol, and/or text, such as “OK”, “SAFE” or “NEW”. On the other hand, the second cross-section C2 of the wear indicator 10 can be shaped such as to be associative with “wear”, “stopping”, “bad”, “negative” and/or “danger”, and may comprise a symbol, such as for instance a thumbs down symbol or an unhappy smiley “:(” or a minus sign “−”, and/or text, such as “STOP”, “WORN” or “REPLACE”.

In embodiments, the orientation of the form or shape of one or both cross-sections, especially a text and/or figure such as a symbol, can be such that it can be read relatively easily when looking at the conveyor mat or chain from the side, such as is the case with the minus sign shown in FIG. 1D. Alternatively or additionally, the orientation of the form of one or both cross-sections can be chosen differently. For instance, the form can be oriented such as to be read easily when looking onto a mat or chain substantially in a direction in which the wear indicator is moving away from an observer, as can be seen in FIGS. 1B and 1C, or a direction in which the wear indicator is approaching the observer. Seen in a direction transverse to the outer face 11, a bottom side of the form may thus be substantially facing a lateral side of a mat, chain and/or module 1, such as in FIG. 1D, a front side 8, or a rear side 9, such as in FIGS. 1B and 1C.

The first cross-section C1 of the wear indicator 10 can thus have a different form than the second cross-section C2 of the wear indicator 10, for example by providing it with a different contour, as is the case with the minus symbol and the plus symbol in FIG. 1D.

At least a part of the form of the first cross-section C1 and at least a part of the form of the second cross-section C2 can be oriented differently with respect to the outer face 11. For example, the form of the second cross-section or part thereof is turned with respect to the first cross-section. In FIG. 1C, an embodiment is shown having a first cross-section C1 in which an arrow is pointing in a first direction, towards a text and/or symbol associative with an unworn state, and having a second cross-section C2 in which a differently oriented arrow is pointing in a second direction, towards a text and/or symbol associative with a worn state.

It is noted that the wear indicator 10 may comprise one or more intermediate cross-sections, preferably having a visual appearance other than the visual appearances of the first and second cross-sections C1, C2. For example, in the embodiment of FIG. 1C the orientation of the arrow can be in between the orientation of the arrows corresponding with the first and second cross-sections. Alternatively or additionally to the orientation, the size, another aspect of the shape or form such as the contour, and/or the color or color scheme of one or multiple intermediate cross-sections may be different from the first and second cross-sections C1, C2, preferably in such a manner that the visual appearance of said intermediate cross-section CI forms a visually intermediate step between the first and second appearance, which may be associative with a semi-worn state of the conveyor module 1.

FIGS. 3A-3D show schematic side views of further embodiments of conveyor modules according to the invention in their unworn states.

The wear indicator 10 can have a visual appearance which is changing along the direction 12 in which the second cross-section C2 is offset from the first cross-section C1. For instance, the wear indicator 10 can have a changing cross-section contour, size and/or color or color scheme, which is changing along said direction 12. Such change can, or at least a part of said change, can be substantially at once, such as the direct color change of the wear indicator in FIG. 3A. Alternatively or additionally, the change or part thereof can be substantially gradually or so-called smoothly, such as in case of the smooth change in size of the diameter of consecutive cross-sections in FIGS. 3B and 3D. Alternatively or additionally, the changing or part thereof can be substantially step-by-step, such as in the exemplary embodiment of FIG. 3C.

As noted above, it is apparent that the wear indicator 10 may have more than two different cross-sections. For example, one or multiple intermediate cross-sections CI can be provided between the first and second cross-section, as is shown in FIG. 3C. Additionally or alternative, the wear indicator 10 can comprise one or multiple further cross-sections C3, C4 provided deeper into the conveyor module than the second cross-section C2, which may have another visual appearance than the first and second cross-sections, which visual appearance can be associative with a state of wear beyond a normal worn state, for instance a state of high risk and/or danger. It is noted that the one or more further cross-sections C3, C4 of the wear indicator 10 can be shaped such as to be associative with “excessive wear” or “danger”, and may for instance comprise a symbol, such as for instance a skull and/or text, such as “DANGER” or “STOP”.

The invention also relates to a conveyor mat or conveyor chain, preferably a modular mat or chain comprising a series of successive modules which are hingedly coupled, such as with the aid of hinge pins reaching through cooperating hinge openings 6, 7 of adjacent modules. More preferably, at least one of the modules comprises at least one marking body 10, e.g. a wear indicator, as described above. However, the mat or chain may alternatively be a substantially non-modular mat or chain provided with at least one marking body 10. It is noted that each of the features of a marking body 10, e.g. a wear indicator, described above in the context of a conveyor module 1 for a modular conveyor mat and/or chain may also be applied with a non-modular mat or chain. The mat or chain comprises a conveying face for supporting articles to be conveyed, a supporting face arranged to be supported by a support member of a conveyor system, and at least marking body 10 for marking the mat or chain, the marking body 10 extending substantially from inside 105 the conveyor mat or conveyor chain or a module thereof at least in a direction towards the outer face 2,4 of the mat or chain or module 1 thereof.

Further, the invention relates to a method for monitoring wear of a conveyor element, such as a modular conveyor mat and/or conveyor chain, and/or a conveyor module 1. The method comprises visually observing an outer surface 11 of the conveyor element. The observing may be done by a human observer and/or can be executed by a non-human observer or apparatus, such as a camera or camera system. The method further comprises detecting one or more wear indicators 10 included in the conveyor element, the or each wear indicator extending from an outer face 11 of the element in a direction 12 into the element, and being arranged such that a first cross-section C1 of the wear indicator 10 located at said outer face 11 has a different visual appearance than a second cross-section C2 of the wear indicator 10 offset from the first cross-section C1 in the direction 12 into the conveyor element. For instance, the at least one wear indicator 10 may be detected by detecting a color differing from a color of material surrounding the wear indicator 10. A present state of visual appearance of the one or more wear indicators 10 is observed and said observed present state is compared with a predetermined state of visual appearance, such as a state corresponding with a worn conveyor element. For example, the observed size, color, shape and/or orientation of the wear indicator can be compared with a predetermined size, color, shape and/or orientation that corresponds with an un-worn state of conveyor element and/or it may be compared with a predetermined size, color, shape and/or orientation that corresponds with a worn state. Hence, it can be concluded whether the conveyor element is still suitable for use or is worn to such extend that it is desirable to replace it. Alternatively or additionally, a visual appearance of the present state of the visual appearance of the one or more wear indicators 10 can included a mutual distance between two or more wear indicators 10, provided in a single or in different modules 1, or between two or more parts of a single wear indicator 10, such as for instance shown in FIG. 2.

At the left-hand side of FIG. 2, an unworn conveyor module 1 is shown having a relatively small wear indicator 10 which includes at least two mutually offset parts 10A, 10B that are both visibly noticeable with respect to the surrounding material in a first cross-section C1 of said wear indicator 10. At a detail showing said wear indicator 10 at the right-hand side of FIG. 2, it can be seen that visible portions of both parts 10A, 10B come to lie further apart as the outer face 11, here the supporting face 4, wears. Although such a small visible change between a first and a second cross section C1, C2 may perhaps not be visible well enough for a human observer, such a small difference may be well recognizable by a system provided with a camera. Although the two parts 10A, 10B are here shown as being offset in the conveying direction 13, different parts of the wear indicator 10 can advantageously be offset in a direction substantially transverse to the conveying direction 13, seen in a direction transverse to the respective outer surface 11, such that the conveying speed will not affect the observed mutual distance between said two parts 10A, 10B.

It is noted that the at least two parts are here integrated in a single wear indicator 10 which can be a single insert, but that the two parts can alternatively be formed by two separate indicators and/or inserts.

In embodiments, the method can further comprise the step of generating a warning signal when the comparison turned out that the observed present state of visual appearance of the at least one wear indicator 10 corresponds or does not correspond with a predetermined state of visual appearance. For instance, when the observed state does correspond with a predetermined state corresponding with a worn conveyor element, or when the observed state does not correspond with a predetermined state corresponding with an un-worn conveyor element, the warning signal may be generated. The warning signal can for instance comprise a visual and/or audible signal, and/or may include a data signal, such as a signal for automatically stopping the conveyor element, e.g. by activating a brake and/or by deactivating a drive or actuator for driving the conveyor element and/or a mat or chain in which said element may be included.

In embodiments, a conveyor system comprising a conveyor element, such as a conveyor module and/or a conveyor mat or chain as described above, can be arranged for executing the above described method for monitoring wear of said conveyor element.

In the conveyor system, one or more cameras can be arranged and positioned for visually observing one or more outer surfaces 11 of the conveyor element. For example, when wear of the conveying face 2 is to be monitored or checked, the camera can be located above un upper side of a top run, preferable a free part of the top run not conveying articles, or below the bottom run. Alternatively or additionally, a camera may be located such as to observe a supporting face 4 of the conveyor element, for instance a substantially upward facing supporting face 4 of the returning bottom run. Further, the system can comprise an electronic circuit arranged for obtaining data from the at least one camera, the data corresponding to a present state of visual appearance of the one or more wear indicators 10 observed by the at least one camera, the electronic circuit further being arranged for comparing said data with data corresponding to a predetermined state of visual appearance.

It is noted that the wear indicator according to an aspect of the invention cannot only be used for monitoring and/or detecting wear of one or more outer faces 11 subject to wear, such as conveying and/or supporting faces 2, 4, but may alternatively or additionally be used for monitoring, checking, and/or detecting wear of connectors 6, 7, such as wear of hinge holes 6, 7 and/or hinge pins and/or detecting increase of play between two or more succeeding conveyor modules 1. For example, when is detected that the mutual distance between tow wear indicators 10 each provided in another one of two conveyor modules 1 has increased, this may indicate that one or more of the connectors via which these modules are connected are worn.

The invention is not restricted to the embodiments described above. It will be understood that many variants are possible.

For example, the conveyor module 1 shown in the exemplary embodiments, each merely consists of a molded body part 100 comprising the conveying and supporting faces 2, 4 and the connectors 6, 7 and the at least one marking body, or consists of a molded body part 100 and a therein provided marking body, e.g. a wear indicator 10. However, in alternative embodiments of a conveyor module according to the invention, the module 1 and/or its module body 100 may comprise one or more additional parts. For example, the conveying face 2 can partly or completely be formed by a conveying part, attached to an upper side of the body part. The conveying part, e.g. a substantially plate-shaped part, may be relatively rigid and/or wear-resistant with respect to the body part, especially a molded body part, and may for instance be made of a metal of metal alloy.

Further, it is noted that an offset distance between the first and the second cross-sections can correspond with a thickness of a top layer of the respective outer face which may wear off before the conveyor element should be replaced. For instance depending on the maximum tolerable wear and/or the thickness of the conveyor element, the second cross-section can for example be positioned between 0.5 mm and 10 mm, especially between 1 mm and 5 mm, below the first cross-section provided by the outer face of an unworn conveyor element.

These and other embodiments will be apparent to the person skilled in the art and are considered to lie within the scope of the invention as formulated by the following claims.

1. A conveyor module for a conveyor mat and/or conveyor chain for conveying articles, said module comprising:
a conveyor module body having outer faces including a conveying face and a supporting face, said conveying face supporting articles to be conveyed, the conveying face being located at a top side of the module, said supporting face being supported by a support member of a conveyor system, the supporting face being located at a bottom side of the module, and connectors arranged such that front and rear sides of successive conveyor modules can be hingedly coupled to each other; and
at least one marking body marking the conveyor module, the marking body extending substantially from inside the module at least in a direction towards an outer face of said outer faces of the module.

2. The conveyor module according to claim 1, wherein said outer face of said outer faces is the conveying face or the supporting face of the module body.

3. The conveyor module according to claim 1, wherein the marking body extends substantially flush with at least one outer face of said outer faces.

4. The conveyor module according to claim 1, wherein the marking body is an insert, especially an insert pressed into a cavity provided in the module body.

5. The conveyor module according to claim 1, wherein the marking body is an insert included in an insert-molded conveyor module such that the conveyor module body is, at least partially, molded around the insert.

6. The conveyor module according to claim 1, wherein the marking body is held in a cavity provided in the module body in form closure and/or by plastic deformation.

7. The conveyor module claim 1, wherein the marking body is provided with a material being different than a local material of the conveyor module body adjacent to the marking body.

8. The conveyor module according to claim 1, wherein the module body is manufactured from and/or includes metal.

9. The conveyor module claim 1, wherein the marking body is manufactured from and/or includes plastic.

10. The conveyor module claim 1, wherein the marking body is provided with a color or color scheme being different than a color or color scheme of local material of the conveyor module body adjacent to the marking body.

11. The conveyor module according to claim 1, wherein different cross-sections of the marking body, which cross-sections are located along at least a part of the path along which the marking body extends at least in the direction towards the outer face of the module, have substantially the same visual appearance, cross-section contour, size and/or color or color scheme.

12. The conveyor module claim 1, wherein the conveyor module is a couple module and the marking body is a couple module indicator for indicating that the module is a couple module of a conveyor mat or conveyor chain.

13. The conveyor module claim 1, wherein the marking body is a wear indicator for visual inspection of wear of the conveyor module.

14. The conveyor module according to claim 13, wherein a first cross-section of the wear indicator located at the outer face of the conveyor module has a different visual appearance than a second cross-section of the wear indicator offset from the first cross-section in the direction into the module.

15. The conveyor module according to claim 14, wherein the visual appearance of the first cross-section is associative with an unworn conveyor module, and the visual appearance of the second cross-section is associative with a worn conveyor module.

16. The conveyor module according to claim 14 Original, wherein the first cross-section of the wear indicator has a different size than the second cross-section of the wear indicator.

17. The conveyor module according to claim 14, wherein the first cross-section of the wear indicator has a different form than the second cross-section of the wear indicator.

18. The conveyor module according to claim 14, wherein the form of the first cross-section of the wear indicator has a different contour than the second cross-section of the wear indicator.

19. The conveyor module according to claim 14, wherein at least a part of the form of the first cross-section and at least a part of the form of the second cross-section are oriented differently with respect to the outer face of the outer faces.

20. The conveyor module according to claim 14, wherein the first cross-section of the wear indicator is provided with a color or color scheme being different than a color or color scheme of the second cross-section of the wear indicator.

21. The conveyor module according to claim 14, wherein the first cross-section and/or the second cross-section of the wear indicator is provided with a color or color scheme being different than a color or color scheme of local material of the conveyor module body adjacent the wear indicator.

22. The conveyor module according to claim 14, wherein the wear indicator has a changing cross-section contour, size and/or color or color scheme, which is changing along the direction in which the second cross-section is offset from the first cross-section, at least a part of the changing being substantially gradually, step-by-step, and/or substantially at once.

23. The conveyor module according to claim 1, wherein the connectors include hinge holes for receiving hinge pins for hingedly coupling front and rear sides of successive conveyor modules to each other.

24. A conveyor mat or conveyor chain comprising:
outer faces including a conveying face and a supporting face, said conveying face supporting articles to be conveyed, and said supporting face arranged to be-supported by a support member of a conveyor system; and
at least one marking body marking the conveyor mat or conveyor chain or a module thereof, the marking body extending substantially from inside the conveyor mat or conveyor chain or a module thereof at least in a direction towards an outer face of said outer faces of the mat or chain or a module thereof.

25. A method for monitoring wear of a conveyor element, such as a modular conveyor mat and/or conveyor chain, the method comprising the steps of:
visually observing an outer surface of the conveyor element;
detecting one or more wear indicators included in the conveyor element, the or each wear indicator extending substantially from inside the element at least in a direction towards an outer face of the element, and being arranged such that a first cross-section of the wear indicator located at said outer face has a different visual appearance than a second cross-section of the wear indicator offset from the first cross-section in the direction into the conveyor element;
observing a present state of visual appearance of the one or more wear indicators; and
comparing said observed present state with a predetermined state of visual appearance.

26. The method according to claim 25, further comprising the step of generating a warning signal when the comparison reveals that the observed present state of visual appearance of the wear indicator indicates a worn conveyor element.

27. A conveyor system, comprising a conveyor element, the conveyor element being a conveyor module according to claim 1.

28. The conveyor system according to claim 27, further comprising:
a camera arranged and positioned for visually observing an outer surface of the conveyor element; and
an electronic circuit arranged for obtaining data from the camera, the data corresponding to a present state of visual appearance of the one or more marking bodies, e.g. wear indicators, observed by the camera, the electronic circuit further being arranged for comparing said data with data corresponding to a predetermined state of visual appearance, such as a state corresponding with a worn conveyor element.
